(19) United States
(12) Patent Application Publication
(10) Pub. No.: US 2007/0002125 A1
(43) Pub. Date: Jan. 4, 2007

(54) Image forming apparatus and image forming method

(75) Inventor: Hiroyuki Kunugi, Numazu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: Kabushiki Kaisha Toshiba, Minato-ku (JP); Toshiba Tec Kabushiki Kaisha, Shinagawa-ku (JP)

(21) Appl. No.: 11/477,171

(22) Filed: Jun. 28, 2006

(30) Foreign Application Priority Data
Jun. 30, 2005 (JP) 2005-190974

(51) Int. Cl. B41J 2/47; G01D 15/14

(52) U.S. Cl. 347/225

(57) ABSTRACT

A technique suppresses the influence of the components that can give rise to fluctuations in the magnetic field and arranged near the motor for driving the polygon mirror on the operation of driving the motor without obstructing the trend of downsizing image forming apparatus. An image forming apparatus comprises a motor that drives a polygon mirror for forming a scanning pattern on the photosensitive surface of a photosensitive material by scanning light, a development section that forms a toner image on the photosensitive surface by means of magnets that can reciprocate relative to the photosensitive surface and a magnetic body that is arranged in a predetermined region between the motor and the development section and shields the magnetic force of the magnets of the development section to prevent it from influencing the motor.

### BACKGROUND OF THE INVENTION

1. Field of the Invention

This invention relates to an image forming apparatus and an image forming method.

2. Description of the Related Art

Image forming apparatus of recent years have been made to have a smaller internal space because of the trend of downsizing and providing an internal delivery system. As a result, development units (development section), cleaner unit, write optical unit and other units are arranged closer to each other than ever. Not ball bearing type but hydrodynamic bearing type motors are in the main stream of motors for driving the polygon mirror mounted in the write optical unit.

A hydrodynamic bearing type motor comprises a rotor section carrying a polygon mirror and a stator section arranged at the motor main body side where a coil and other components are disposed. A gap of about several micrometers to tens of several micrometers is provided between the rotor section and the stator section and, in the case of an oil hydrodynamic bearing type motor, the gap is filled with oil. On the other hand, in the case of an air hydrodynamic bearing type motor, the gap is filled with air. When the motor is driven to rotate, the rotor and the stator are completely held in a non-contact state by means of magnetic force in the thrust directions and by means of the pressure of oil or air in the radial directions.

Meanwhile, image forming apparatus comprising development units of three colors of cyan (C), magenta (M) and yellow (Y) or of four colors including those three colors and black arranged in a rotary member, which is referred to as revolver, and adapted to print color images by driving the revolver to rotate for the purpose of realizing space-saving color printing operations are known.

To meet the demand for downsized image forming apparatus in recent years, the units of the apparatus are generally arranged closer to each other than ever as pointed out above. Then, the development section of the revolver is more often than not arranged immediately above the write optical system that includes a polygon mirror and the like.

Magnet rollers are arranged in the revolver for the purpose of developing an electrostatic latent image on the photosensitive surface of the photosensitive material of the image forming apparatus by means of toners. When the revolver is driven to rotate, the magnet rollers pass near the motor for driving the polygon mirror that is arranged in the write optical unit.

While a hydrodynamic bearing type motor is employed more often than not to drive the polygon mirror to rotate as pointed out above, the operation of driving the polygon mirror is apt to be influenced by the changing magnetic field because the positional relationship of the rotor and the stator is not mechanically regulated (unlike ball bearing type motors).

For this reason, the magnetic force that is floating the rotor of the motor for driving the polygon mirror can become off balanced because of the fluctuations in the magnetic field due to the passage of the magnet rollers of the revolver, to make the polygon mirror rotate unevenly so as to give rise to noisy images where a color shift and/or a blur appear.

### SUMMARY OF THE INVENTION

In view of the above-identified problems of the prior art, it is therefore the object of the present invention to provide a technique of suppressing the influence of the components that can give rise to fluctuations in the magnetic field and arranged near the motor for driving the polygon mirror on the operation of driving the motor without obstructing the trend of downsizing image forming apparatus.

In an aspect of the present invention, the above object is achieved by providing an image forming apparatus comprising: a motor that drives a polygon mirror for forming a scanning pattern on the photosensitive surface of a photosensitive material by scanning light; a development section that forms a toner image on the photosensitive surface by means of magnets that can reciprocate relative to the photosensitive surface; and a magnetic body that is arranged in a predetermined region between the motor and the development section and shields the magnetic force of the magnets of the development section to prevent it from influencing the motor.

In another aspect of the present invention, there is provided an image forming apparatus comprising: a magnetic drive means for driving a polygon mirror for forming a scanning pattern on the photosensitive surface of a photosensitive material by scanning light; a development means for forming a toner image on the photosensitive surface by means of magnets that can reciprocate relative to the photosensitive surface; and a magnetism shielding means arranged in a predetermined region between the magnetic drive means and the development means for shielding the magnetic force of the magnets of the development section to prevent it from influencing the magnetic drive section.

In still another aspect of the present invention, there is provided an image forming method comprising: arranging a magnetic body in a predetermined region between a motor and a development section to shield the magnetic forces of the magnets of the development section to prevent it from influencing the motor; when forming a scanning pattern on the photosensitive surface of a photosensitive material by scanning light by driving a polygon mirror by means of a motor and then forming a toner image on the photosensitive surface by means of the magnets that can reciprocate relative to the photosensitive surface.

As described above in detail, according to the present invention, there is provided a technique of suppressing the influence of the components that can give rise to fluctuations in the magnetic field and arranged near the motor for driving the polygon mirror on the operation of driving the motor without obstructing the trend of downsizing image forming apparatus.

### BRIEF DESCRIPTION OF THE DRAWINGS

FIG. 1 is a schematic illustration of an embodiment of image forming apparatus according to the present invention, showing the arrangement of the polygon mirror and the components disposed around the polygon mirror;

FIG. 2 is another schematic illustration of the embodiment of FIG. 1, showing the arrangement of the polygon mirror and the components disposed around the polygon mirror; and

FIG. 3 is a schematic plan view of the write optical unit 1 of the embodiment of FIG. 1, where the magnetic body 101 is arranged outside the cabinet of the embodiment.

### DETAILED DESCRIPTION OF THE PREFERRED EMBODIMENT

Now, the present invention will be described in greater detail by referring to the accompanying drawings that illustrate a preferred embodiment of the invention.

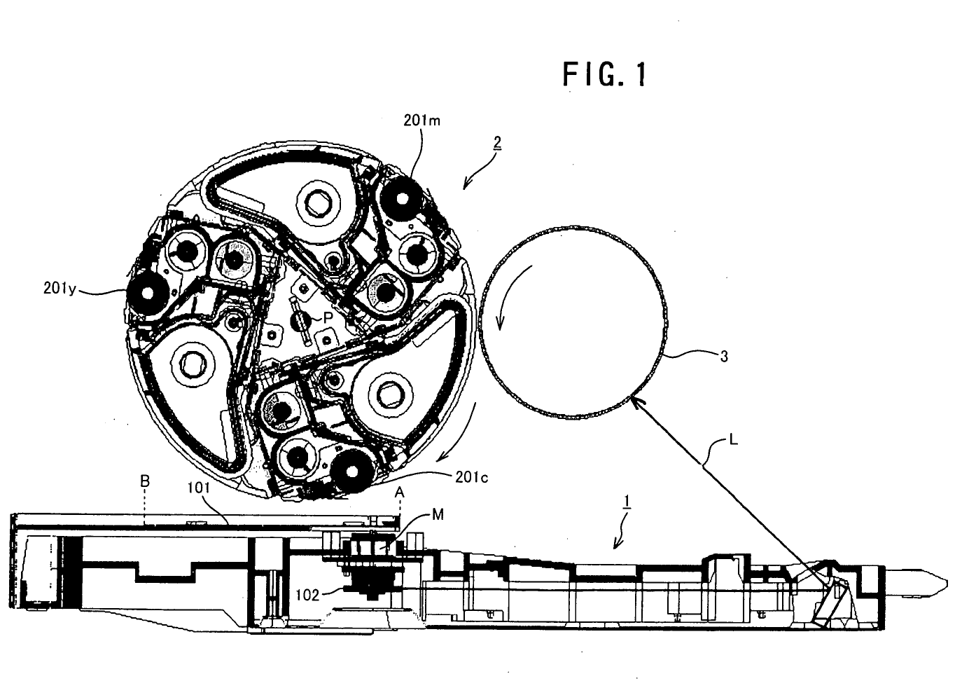

FIG. 1 is a schematic illustration of the embodiment of image forming apparatus according to the present invention, showing the arrangement of the polygon mirror and the components disposed around the polygon mirror.

As shown in FIG. 1, the write optical unit 1 of this embodiment of image forming apparatus is arranged below the photosensitive material 3 and the revolver 2 for forming an image by means of toners of different colors on the photosensitive surface of the photosensitive material 3.

The revolver (development section) 2 takes the role of forming a toner image on the photosensitive surface by means of magnet rollers (magnets) 201c-201y that can reciprocate relative to the photosensitive surface of the photosensitive material 3. The revolver 2 reciprocates each of the magnet rollers relative to the photosensitive surface of the photosensitive material 3 by driving it to rotate around an axis of rotation P (predetermined axis).

The polygon mirror 102 for forming a scanning pattern on the photosensitive surface of the photosensitive material 3 by scanning a laser beam L is arranged under the top plate of the cabinet of the write optical unit 1. In the case of the write optical unit 1 illustrated in FIG. 1, the polygon mirror 102 is driven to rotate by an air hydrodynamic bearing type motor M arranged above the top plate of the cabinet of the write optical unit 1.

As a voltage, a start/stop signal and a revolution directing clock are externally input, the winding of the motor is magnetically excited and the motor M drives the polygon mirror 102 to revolve at a number of revolutions per unit time that accords to the clock. When the number of revolutions per unit time exceeds a certain value, the motor M revolves totally in a non-contact manner as it is supported in the radial directions by dynamic pressure of air and in the thrust directions by the magnetic force of the magnets.

This embodiment of image forming apparatus additionally comprises a magnetic body 101 that is arranged in a predetermined region between the motor M and the revolver 2.

Since the motor M is arranged above the write optical unit 1 as shown in FIG. 1, the magnet rollers 201c, 201m and 201y arranged on the revolver 2 is brought close to the motor M when the revolver 2 revolves (with the shortest gap of separation of about 20 mm). Note that the revolver 2 has a diameter of 170 mm and the photosensitive material 3 has a diameter of 90 mm.

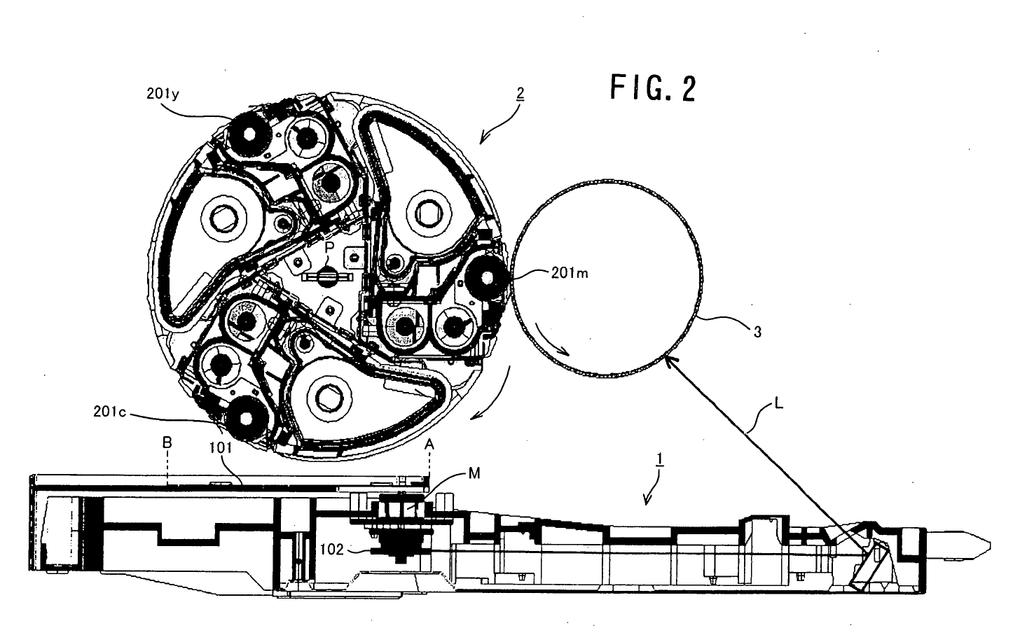

In FIG. 1, the magnet roller 201c for developing a latent image by means of cyan toner is brought close to the motor M. In FIG. 2, on the other hand, the magnet roller 201c has passed near the motor M and the succeeding magnet roller, or the magnet roller 201m, is being brought close to the motor M.

In the condition of FIG. 2, the revolver 2 stops revolving and the bristles of the magnetic brush of the magnet roller 201m are brought into contact with the photosensitive material 3 to form a magenta toner image.

As pointed out above, when any of the magnet rollers 201c-201y passes near the motor M, the fluctuations of the magnetic field due to the movement of the magnet roller that exerts magnetic force can influence the driving operation of the motor.

Therefore, in this embodiment, the magnetic body 101 operates as shield to prevent the magnetic force of any of the magnetic rollers 201c-201y of the revolver 2 from influencing the motor M. By arranging such a magnetic body 101, it is possible to avoid any adverse influence of the component or components arranged near the motor M for driving the polygon mirror to rotate that can give rise to fluctuations in the magnetic field of the revolver 2, on the operation of driving the motor M.

The above-described magnetic body 101 is made of a magnetic material such as a zinc-plated steel plate (SECC) or a chromium-free steel plate. Then, as a result, the fluctuations, if any, of the magnetic field is prevented from influencing the motor M even when the cabinet of the write optical unit 1 is made of a material that does not operate as magnetic shield.

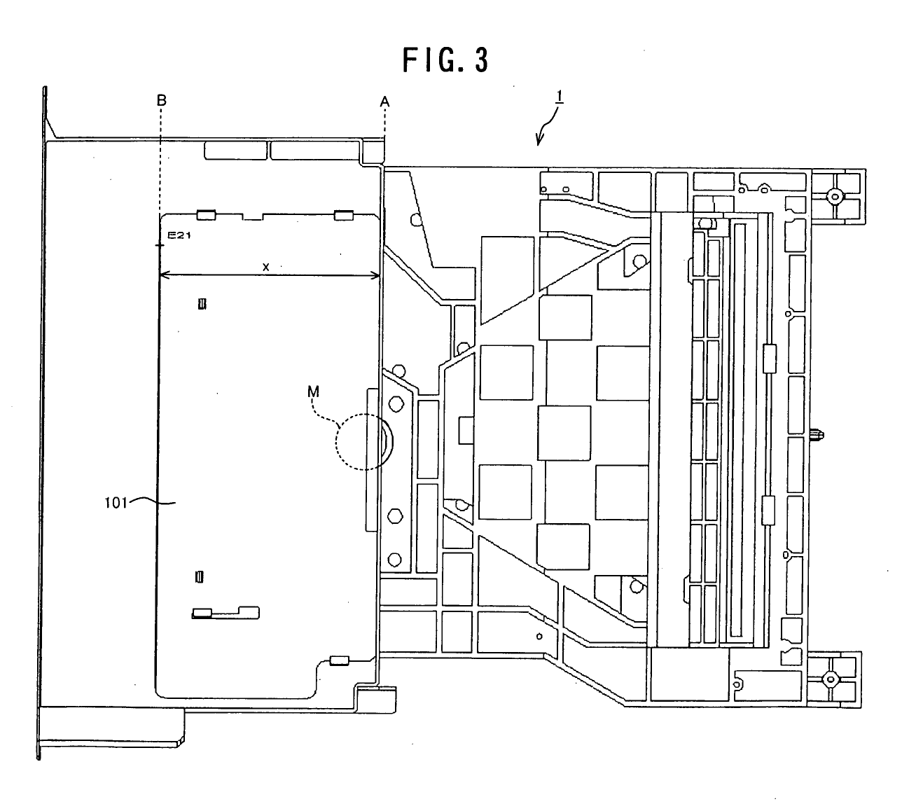

When the revolver 2 (development section) is arranged at a level different from the level of the motor M as shown in FIGS. 1 and 2, the magnetic body 101 is preferably so arranged that it at least horizontally extends toward the revolver 2. FIG. 3 is a schematic plan view of the write optical unit 1 of the embodiment of FIG. 1, where the magnetic body 101 is arranged outside the cabinet of the embodiment. As shown in FIG. 3, the magnetic body 101 is arranged to cover the range between A and B and the distance between A and B is defined to be 100 mm to 120 mm. With this arrangement, the magnetic force of any of the magnet rollers of the revolver 2 is prevented from winding toward the motor M and hence from influencing the motor M.

While the motor M of this embodiment is an air hydrodynamic bearing type motor in the above-description, the present invention is by no means limited thereto and the present invention is particularly effective when the motor M is of a type whose rotary drive motion is apt to be influenced by fluctuations of a magnetic field such as an oil hydrodynamic bearing type motor.

Thus, with the above-described embodiment, even when one or more than one objects that can change magnetic force and/or one or more than one units that can apparently change magnetic force due to their own motions (operations) are arranged near the motor for driving the polygon mirror, it is possible to suppress the adverse influence on the motor due to the change of magnetic force. Then, as a result, it is possible to provide images of high quality that are free from a color shift and/or a blur.

While the present invention is described above by way of a specific embodiment, it may be apparent to those skilled in the art that the embodiment can be modified and/or altered in various different ways without departing the spirit and scope of the present invention.

In the above-description of the embodiment, the motor M, the revolver 2 (development section) and the magnetic body 101 correspond respectively to the magnetic drive section, the development section and the magnetism shielding section of an image forming apparatus according to the present invention.

What is claimed is:

1. An image forming apparatus comprising:
a motor that drives a polygon mirror for forming a scanning pattern on the photosensitive surface of a photosensitive material by scanning light;
a development section that forms a toner image on the photosensitive surface by means of magnets that can reciprocate relative to the photosensitive surface; and
a magnetic body that is arranged in a predetermined region between the motor and the development section and shields the magnetic force of the magnets of the development section to prevent it from influencing the motor.

2. The apparatus according to claim 1, wherein the magnetic body is arranged to extend horizontally so as to shield the development section and the motor from each other at a level between them when the development section and the motor are arranged at different levels.

3. The apparatus according to claim 1, wherein the magnetic body is made of a zinc-plated steel plate.

4. The apparatus according to claim 1, wherein
the magnetic body is made of a chromium-free steel plate.

5. The apparatus according to claim 1, wherein
the development section is adapted to reciprocate relative to photosensitive surface as the magnet is driven to rotate around a predetermined axis, which is the center of rotation.

6. The apparatus according to claim 1, wherein
the motor is borne by an air hydrodynamic bearing.

7. The apparatus according to claim 1, wherein
the motor is borne by an oil hydrodynamic bearing.

8. An image forming apparatus comprising:
a magnetic drive means for driving a polygon mirror for forming a scanning pattern on the photosensitive surface of a photosensitive material by scanning light;
a development means for forming a toner image on the photosensitive surface by means of magnets that can reciprocate relative to the photosensitive surface; and
a magnetism shielding means arranged in a predetermined region between the magnetic drive means and the development means for shielding the magnetic force of the magnets of the development section to prevent it from influencing the magnetic drive section.

9. An image forming method comprising:
arranging a magnetic body in a predetermined region between a motor and a development section to shield the magnetic forces of the magnets of the development section to prevent it from influencing the motor;
when forming a scanning pattern on the photosensitive surface of a photosensitive material by scanning light by driving a polygon mirror by means of a motor and then forming a toner image on the photosensitive surface by means of the magnets that can reciprocate relative to the photosensitive surface.

10. The method according to claim 9, wherein
the magnetic body is arranged to extend horizontally so as to shield the development section and the motor from each other at a level between them when the development section and the motor are arranged at different levels.

11. The method according to claim 9, wherein
the magnetic body is made of a zinc-plated steel plate.

12. The method according to claim 9, wherein
the magnetic body is made of a chromium-free steel plate.

13. The method according to claim 9, wherein
the development section is adapted to reciprocate relative to the photosensitive surface as the magnet is driven to rotate around a predetermined axis, which is the center of rotation.

14. The method according to claim 9, wherein
the motor is borne by an air hydrodynamic bearing.

15. The method according to claim 9, wherein
the motor is borne by an oil hydrodynamic bearing.
